(19) United States
(12) Patent Application Publication
(10) Pub. No.: US 2008/0175275 A1
(43) Pub. Date: Jul. 24, 2008

(54) TIME SYNCHRONIZATION METHOD BETWEEN NODES IN NETWORK AND APPARATUS FOR IMPLEMENTING THE SAME

(75) Inventors: Geoffrey M. GARNER, Red Bank, NJ (US); Cornelis Johannis Den Hollander, Suwon-si (KR); Hong Kyu Jeong, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/846,031

(22) Filed: Aug. 28, 2007

Related U.S. Application Data
(60) Provisional application No. 60/881,520, filed on Jan. 22, 2007.

(30) Foreign Application Priority Data
Mar. 16, 2007 (KR) 2007-26336

(51) Int. Cl. H04J 3/06

(52) U.S. Cl. 370/503

(57) ABSTRACT

A time synchronization method between nodes in a network and an apparatus for implementing the same, the time synchronization method including: measuring a value of a propagation time from a slave node to a master node using a time stamp for each of one or more predetermined time units; calculating an estimate of an actual propagation time using the one or more measured values and a sliding window; and computing an offset using a message transmission time corresponding to a sending of a message from the master node, a message receipt time corresponding to an arrival of the message at the slave node, and the estimate of the actual propagation time.

### CROSS-REFERENCE TO RELATED APPLICATIONS

This application claims the benefit of U.S. Provisional Application No. 60/881,520, filed in the U.S. Patent and Trademark Office on Jan. 22, 2007, and Korean Application No. 10-2007-26336, filed in the Korean Intellectual Property Office on Mar. 16, 2007, the disclosures of which are incorporated herein by reference.

### BACKGROUND OF THE INVENTION

1. Field of the Invention

Aspects of the present invention relate to a time synchronization method between nodes in a network and an apparatus for implementing the same, and more particularly, to a time synchronization method between nodes in a network and an apparatus for implementing the same that can improve jitter, wander, and a time synchronization function when performing a time synchronization based on a time stamp between the nodes in the network.

2. Description of the Related Art

Currently, a variety of schemes to transmit timings between nodes of a network using time stamps exist (for example, Institute of Electrical and Electronics Engineers (IEEE) 1588 protocol and network time protocol (NTP)). In such schemes, each node included in the network attempts time synchronizations with a single node of the nodes included in the network. The single node belongs to master nodes, known as masters. Specifically, in such schemes, timings can be traceable in grandmaster nodes, known as grandmasters.

Master nodes transmit messages including time stamps to all nodes connected to the master nodes, except for another master node connected to the master nodes. Here, the time stamps may be the time when the messages are transmitted. Each slave node receives the time stamps and adds propagation times between the slave nodes and the master nodes to the time stamps. Then, slave nodes compare time stamps where propagation times are added (i.e., propagation time-added transmission times from master nodes) to the time when the messages are received. The slave nodes then compute offsets, and can thereby perform a time synchronization. In this instance, the offset corresponds to differences between master nodes and slave nodes.

FIG. 1 is a diagram illustrating an example of a time synchronization method between nodes in a conventional art. Referring to FIG. 1, a master node 101 first transmits a message to a slave node 102. A time stamp T1 is stored in the message. The time stamp T1 is a time 103 when the master node 101 transmits the message. When receiving the message, the slave node 102 confirms a receipt time T2 (i.e., a time 104 when the message is received). When the slave node 102 knows a propagation time D1 from the master node 101, the slave node 102 can compute an offset according to an equation: offset=T2−T1−D1. The offset is a difference between the master node 101 and the slave node 102. Accordingly, the slave node 102 can perform a time synchronization with the master node 101 using the offset.

However, to compute the offset as described above, the slave node 102 must have information about the propagation time D1 from the master node 101. Specifically, the slave node 102 needs to compute the propagation time D1.

The method of computing a propagation time described above and another method of computing a propagation time are described in detail below. Schemes described above and schemes described below do not specify how to compute offsets used in slave nodes. Slave nodes can directly control the computing of the offsets. However, the control of slave nodes results in a large amount of jitter, a large amount of wander, and time synchronization inaccuracies. In many cases, a sequence of offsets is filtered in slave nodes using digitally controlled oscillators (DCOs). When less jitter and less wander are desired, the sequence of offsets is filtered using a phase locked loop (PLL). However, schemes using DCOs and PLLs in slave nodes are expensive. Thus, such schemes are currently used for more stringent applications.

The finite granularity of time stamp measurements is a main source of time inaccuracies. For example, standard Ethernet bridges and end devices need 25 MHz oscillators. In such devices, the granularity of time stamp measurements is 40 ns, which indicates that errors in propagation time measurement can be as much as 80 ns.

In the scheme using peer-to-peer transparent clocks, such errors are accumulated. For N hops (i.e., N links from a master node to a slave node), at least an N−1 number of peer-to-peer transparent clocks exist between a master node and a slave node. Thus, a potential error is 80N ns. As a number of hops increases, such errors can quickly grow to hundreds of ns, or exceed 1 μs. In this case, such errors can be reduced using the PLL filtering described above. However, the PLL filtering is expensive and a storage place for each timing signal is needed, resulting in an increase in expenses. Accordingly, a time synchronization method that can improve jitter, wander, and time synchronization functions without using the expensive PLL filtering is needed.

### SUMMARY OF THE INVENTION

Aspects of the present invention provide a time synchronization method between nodes in a network and an apparatus for implementing the same.

Aspects of the present invention also provide a time synchronization method between nodes in a network and an apparatus for implementing the same which measure values of propagation time based on one or more time stamps for each of one or more predetermined time units, compute an offset from a master node using an average of the measured values and a sliding window, and can thereby improve jitter, wander, and a time synchronization function.

Aspects of the present invention also provide a time synchronization method between nodes in a network and an apparatus for implementing the same which measure values of propagation times based on one or more time stamps for each of one or more predetermined time units, compute an offset from a master node using an average of the measured values and a linear digital filter, and can thereby improve jitter, wander, and a time synchronization function.

Aspects of the present invention also provide a time synchronization method between nodes in a network and an apparatus for implementing the same which compute a first offset from a master node for each of one or more predetermined time units, compute a second offset (i.e., an offset of a current time unit) via a linear digital filter that has the one or more first offsets computed for previous time units as an input value, and can thereby improve jitter, wander, and a time synchronization function as well as consider a residence time in an intermediate relay device.

According to an aspect of the present invention, there is provided a time synchronization method between nodes in a network, the time synchronization method including: measuring a value of a propagation time from a slave node to a master node using time stamps for each of one or more messages sent from the slave node to the master node; calculating an estimate of an actual propagation time using the one or more measured values and a sliding window; and computing an offset using a message transmission time corresponding to a sending of a message from the master node, a message receipt time corresponding to an arrival of the message at the slave node, and the estimate of the actual propagation time.

The calculating of the estimate may include: maintaining a number of the one or more measured values corresponding to a length of the sliding window, the measured values being most recently measured; and calculating a second estimate of the actual propagation time as the estimate using a first estimate that is calculated from an average of the maintained measured values excluding the current measured value.

The calculating of the second estimate calculates the second estimate according to equations:

$${D}_{k} = {D}_{k - 1} + \frac{{d}_{k} - {d}_{k - M}}{M}$$

$$H ( z ) = \frac{1}{M} \cdot \frac{1 - {z}^{- M}}{1 - {z}^{- 1}} .$$

where dₖ is the measured value corresponding to a k^{th} message, Dₖ is the second estimate, M is the length of the sliding window, and H(z) is a transfer function for a difference equation for Dₖ.

According to another aspect of the present invention, there is provided a time synchronization method between nodes in a network, the time synchronization method including: measuring a value of a propagation time from a slave node to a master node using time stamps for each of one or more messages sent from the slave node to the master node; calculating an estimate of an actual propagation time using the one or more measured values and a linear digital filter; and computing an offset using a message transmission time corresponding to a sending of a message from the master node, a message receipt time corresponding to an arrival of the message at the slave node, and the estimate of the actual propagation time.

The calculating of the estimate may include: maintaining an n number of measured values; maintaining an m number of first estimates, each first estimate being calculated from previous measured values; and calculating a second estimate which is the estimate of the actual propagation time using the n number of measured values, the m number of first estimates, and the linear digital filter, wherein the linear digital filter provides the n number of measured values and the m number of first estimates with a plurality of filter coefficients, and calculates a sum as the second estimate, the sum corresponding to a sum of the n number of measured values and the m number of first estimates where the plurality of filter coefficients are provided.

According to still another aspect of the present invention, there is provided a time synchronization method between nodes in a network, the time synchronization method including: computing a first offset from a master node using one or more time stamps for each of one or more messages sent from the master node to a slave node; and computing a second offset using the one or more first offsets and a linear digital filter.

According to yet another aspect of the present invention, there is provided an apparatus for performing a time synchronization between nodes in a network, the apparatus including: a measured value measurement unit to measure a value of propagation time from a slave node to a master node using time stamps for each of a plurality of messages sent from the slave node to the master node; an estimate calculation unit to calculate an estimate of an actual propagation time using the plurality of measured values and a sliding window; and an offset computation unit to compute an offset using a message transmission time corresponding to a sending of a message from the master node, a message receipt time corresponding to an arrival of the message at the slave node, and the estimate of the actual propagation time.

According to another aspect of the present invention, there is provided an apparatus for performing a time synchronization between nodes in a network, the apparatus including: a measured value measurement unit to measure a value of a propagation time from a slave node to a master node using time stamps for each of a plurality of messages sent from the slave node to the master node; an estimate calculation unit to calculate an estimate of an actual propagation time using the plurality of measured values and a linear digital filter; and an offset computation unit to compute an offset using a message transmission time corresponding to a sending of a message from the master node, a message receipt time corresponding to an arrival of the message at a slave node, and the estimate of the actual propagation time.

According to still another aspect of the present invention, there is provided an apparatus for performing a time synchronization between nodes in a network, the apparatus including: a first offset computation unit to compute a first offset from a master node using one or more time stamps for each of one or more messages sent from the master node to a slave node; and a second offset computation unit to compute a second offset using the one or more first offsets and a linear digital filter.

According to another aspect of the present invention, there is provided a time synchronization method between nodes in a network, the time synchronization method including: measuring a value of a propagation time from a slave node to a master node using time stamps for each of one or more messages sent from the slave node to the master node; calculating an estimate of an actual propagation time using the one or more measured values; and computing an offset using a message transmission time corresponding to a sending of a message from the master node, a message receipt time corresponding to an arrival of the message at the slave node, and the estimate of the actual propagation time.

According to yet another aspect of the present invention, there is provided an apparatus for performing a time synchronization between nodes in a network, the apparatus including: a measured value measurement unit to measure a value of propagation time from a slave node to a master node using time stamps for each of one or more messages sent from the slave node to the master node; an estimate calculation unit to calculate an estimate of an actual propagation time using the one or more measured values; and an offset computation unit to compute an offset using a message transmission time corresponding to a sending of a message from the master node, a message receipt time corresponding to an arrival of the message at the slave node, and the estimate of the actual propagation time.

According to another aspect of the present invention, there is provided a system for performing a time synchronization between nodes in a network, the system including: a master node to receive a plurality of messages; and a slave node including: a measured value measurement unit to measure a value of propagation time from a slave node to a master node using time stamps for each of the plurality of messages sent from the slave node to the master node; an estimate calculation unit to calculate an estimate of an actual propagation time using the plurality of measured values; and an offset computation unit to compute an offset using a message transmission time corresponding to a sending of a message from the master node, a message receipt time corresponding to an arrival of the message at the slave node, and the estimate of the actual propagation time.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating an example of a time synchronization method between nodes in a conventional art;

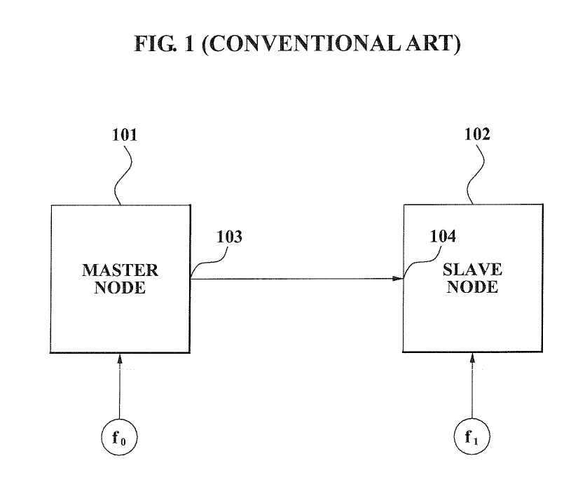

FIG. 2 is a diagram illustrating an example of a method of measuring a propagation time in a conventional art;

FIG. 3 is a diagram illustrating an example of a method of measuring a propagation time when a relay device exists between a slave node and a master node in a conventional art;

FIG. 4 is a diagram illustrating an example of a method of computing an offset using a peer-to-peer transparent clock in a conventional art;

FIG. 5 is a flowchart illustrating a time synchronization method between nodes in a network according to an embodiment of the present invention;

FIG. 6 is a flowchart illustrating a method of computing an estimate of an actual propagation time using a sliding window according to an embodiment of the present invention;

FIG. 7 is a block diagram illustrating a configuration of a slave node according to an embodiment of the present invention;

FIG. 8 is a flowchart illustrating a time synchronization method between nodes in a network according to another embodiment of the present invention;

FIG. 9 is a flowchart illustrating a method of computing an estimate of an actual propagation time using a linear digital filter according to a third embodiment of the present invention;

FIG. 10 is a block diagram illustrating a configuration of a slave node according to another embodiment of the present invention;

FIG. 11 is a diagram illustrating an example of a bidirectional method for a time synchronization according to an embodiment of the present invention;

FIG. 12 is a flowchart illustrating a unidirectional time synchronization method between nodes in a network according to an embodiment of the present invention;

FIG. 13 is a block diagram illustrating a configuration of a slave node according to an embodiment of the present invention; and

FIG. 14 is a diagram illustrating an example of a unidirectional method for a time synchronization according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

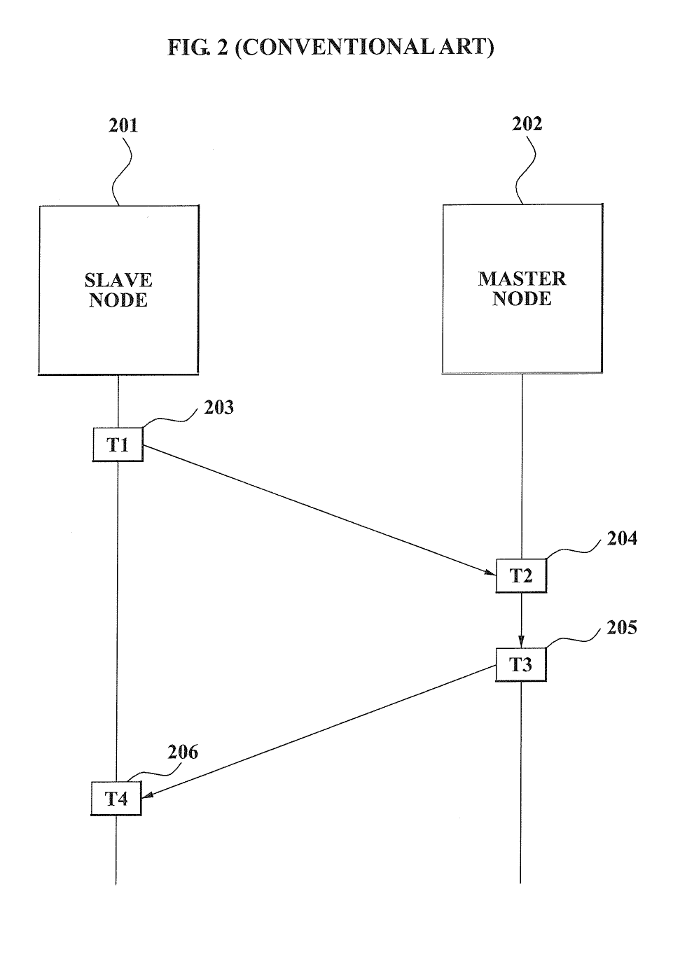

FIG. 2 is a diagram illustrating an example of a method of measuring a propagation time in a conventional art. Referring to FIG. 2, first, a propagation time between clocks attached to two nodes (i.e., a slave node 201 and a master node 202) is measured by the clocks exchanging a time stamp. A requester, which is one of the clocks, stores a transmission time T1 203 of a first message in the first message when transmitting the first message to the other clock. The other clock (a responder) stores a receipt time T2 204 of the first message.

After storing the receipt time T2 204, the responder transmits a second message corresponding to the first message to the requester. The requester stores a transmission time T3 205 of the second message in the second message when transmitting the second message. After transmitting the second message, the requester confirms a receipt time T4 206 of the second message.

The requester can measure the propagation time using the transmission time T1 203 of the first message, the receipt time T2 204 of the first message, the transmission time T3 205 of the second message, and the receipt time T4 206 of the second message. The propagation time can be calculated according to Equation 1:

Propagation time=((T2−T1)+(T4−T3))/2 [Equation 1]

Here, it is assumed that the method of measuring a propagation time satisfies following conditions. First, the propagation time is symmetrical. That is, the propagation time is identical in both directions. Second, the propagation time is stable. That is, a timescale to obtain the above-described four time stamps (i.e., the transmission time T1 203, the receipt time T2 204, the transmission time T3 205, and the receipt time T4 206) is constant. Third, a frequency difference between the slave node 201 and the master node 202 is small. Fourth, time stamp values are accurate.

However, the first condition (the propagation time is symmetrical) and the second condition (the propagation time is stable) indicate that a source of a variable delay between the requester and the responder cannot exist. That is, there cannot exist a relay device (such as a network switch or a network bridge) between the slave node 201 and the master node 202. The existence of such a relay device can cause jitter, wander, and a time synchronization inaccuracy.

If there exists a network switch or a network bridge between the slave node 201 and the master node 202, a propagation time variation and/or a propagation time asymmetry result. To mitigate the propagation time variation and the propagation time asymmetry, the relay device (such as the network switch or the network bridge) stores a receipt time and a transmission time of each message in the message. Accordingly, the relay device includes a clock and a time stamping hardware, known collectively as a transparent clock.

The transparent clock computes a difference between the receipt time and the transmission time of the message. In this instance, the difference is referred to as a residence time. The residence time is accumulated in a field in the message. The accumulated value indicates a variable portion of the propagation time. Specifically, the accumulated value can indicate a variation of the propagation time due to the relay device at the slave node 201.

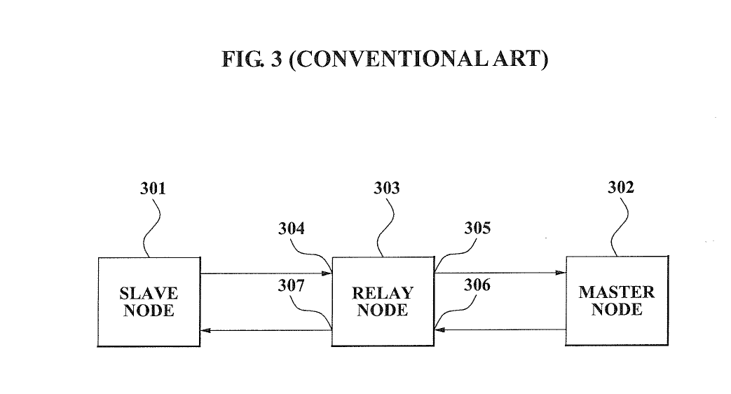

FIG. 3 is a diagram illustrating an example of a method of measuring a propagation time when a relay device exists between a slave node and a master node in a conventional art. Referring to FIG. 3, first, a slave node 301 transmits a first message to a master node 302 via a relay node 303. The master node 302 transmits a second message corresponding to the first message to the slave node 301 via a relay node 303. Accordingly, as described with reference to FIG. 2, a transmission time T1 of the first message, a receipt time T2 of the first message, a transmission time T3 of the second message, and a receipt time T4 of the second message are measured. The first message and the second message are transmitted via the relay node 303. The relay node 303 measures a residence time in the relay node 303 using a transparent clock included in the relay node 303.

Specifically, the relay node 303 computes a difference R1 between a receipt time 304 of the first message and a transmission time 305 of the first message. The relay node 303 also computes a difference R2 between a receipt time 306 of the second message and a transmission time 307 of the second message. The relay node 303 stores the difference R1 in the first message and the difference R2 in the second message. Accordingly, the slave node 301 can ascertain a variation of the propagation time generated by the relay node 303.

The propagation time can be measured by the slave node 301 according to Equation 2:

Propagation time=((T2−T1−R1)+(T4−T3−R2))/2. [Equation 2]

The propagation time between the slave node 301 and the master node 302 is measured after a network reconfiguration, since the approach provides only for a measurement of the propagation time between each slave node and a master node of each slave node, as opposed to the propagation time between every pair of transparent clocks. This approach can cause a loss of synchronization when a network is reconfigured.

According to another approach, the transparent clocks themselves exchange messages to measure a propagation time between the transparent clocks. Specifically, the message exchange is performed between every adjacent pair of transparent clocks, in both directions. The transparent clocks are known as peer-to-peer transparent clocks. Specifically, when the master node 302 and the slave node 301 are connected between the peer-to-peer transparent clocks, the master node 302 transmits, to the slave node, a message where a transmission time of the message is stored, and each of the peer-to-peer transparent clocks stores an accumulated residence time in the message. Also, each of the peer-to-peer transparent clocks stores an accumulated propagation time measured between the peer-to-peer transparent clocks in the message. Specifically, the propagation time of a link where the message arrives is accumulated and stored in the message.

In this instance, the slave node 301 receiving the message can compute an offset from the master node 302 using the transmission time of the message, stored in the message, from the master node 302, the stored accumulated residence time, the stored accumulated propagation time, and a receipt time of the message.

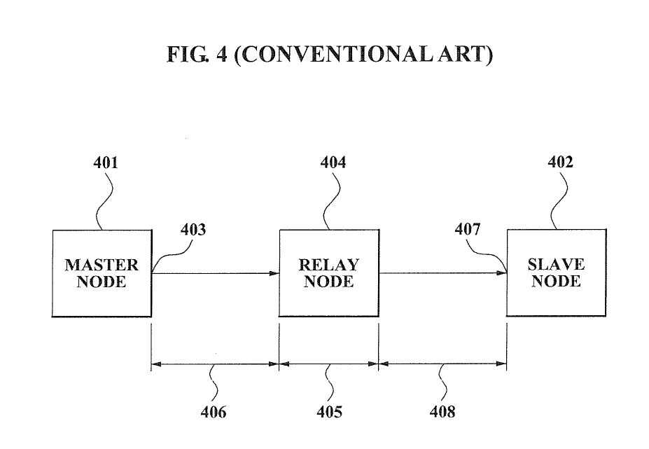

FIG. 4 is a diagram illustrating an example of a method of computing an offset using a peer-to-peer transparent clock in a conventional art. Referring to FIG. 4, first, a master node 401 transmits a message to a slave node 402 via a relay node 404. The message includes a transmission time T1 403 of the message. When the message is transmitted via the relay node 404, the relay node 404 computes a residence time 405 in the relay node 404 and a propagation time 406 of a link receiving the message. Then, the relay node 404 stores the residence time 405 and the propagation time 406 in the message, and transmits the message to the slave node 402.

The slave node 402 measures a receipt time T2 407 of the message and a propagation time D1 408 of a link between a last relay node and the slave node 402. The slave node 402 can compute an offset from the master node 401 using the transmission time T1 403, the residence time 405, the propagation time 406 of the link receiving the message, the propagation time D1 408, and the receipt time T2 407 of the message. For example, the offset from the master node 401 can be computed by the slave node 402 according to Equation 3:

Offset=T2−T1−R1−D1 where R1 can be an accumulated value of the residence time 405 and the propagation time 406. [Equation 3]

In the method of measuring a propagation time described with reference to FIGS. 2 and 3, the propagation time is measured when exchanging a message between a master node and a slave node in order to compute an offset. That is, the method of measuring a propagation time described with reference to FIGS. 2 and 3 is a bidirectional method. The method of computing an offset described with reference to FIG. 4 can compute the offset with an one-time message transmission from the master node 401 to the slave node 402. That is, the method of computing an offset described with reference to FIG. 4 is a unidirectional method.

A time synchronization method according to aspects of the present invention can be used for the following cases. First, a time synchronization method according to aspects of the present invention can be used when each slave node measures a delay with a master node without a transparent clock between the master node and the slave node. Second, aspects of the present invention can be used when each slave node measures the delay with the master node. In this case, at least one end-to-end transparent clock exists between the slave node and the master node. Third, aspects of the present invention can be used when at least one peer-to-peer transparent clock exists between the slave node and the master node. In this case, each propagation time is separately measured between each successive pair of adjacent peer-to-peer transparent clocks. Also, a propagation time between the master node and a first peer-to-peer transparent clock, and a propagation time between the slave node and a last peer-to-peer transparent clock are separately measured.

Here, when a stable propagation time is measured using a clock having a finite phase measurement granularity, measured values of the propagation time tend to fluctuate between two values. Specifically, the two values correspond to a greatest integer multiple of a clock granularity that is less than the propagation time, and a least integer multiple of the clock granularity that is greater than the propagation time.

As the propagation time fluctuates between the two values, an actual propagation time can be measured by averaging subsequent measured values. The average can be computed by a method using a sliding window of a length M and a method using a general linear digital filter exist.

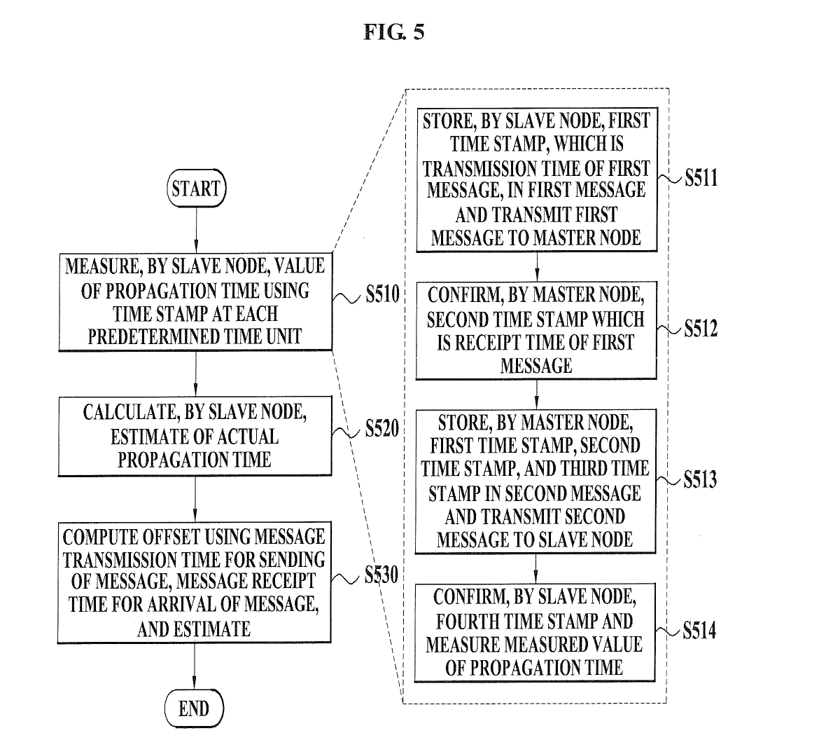

FIG. 5 is a flowchart illustrating a time synchronization method between nodes in a network according to an embodiment of the present invention. In operation S510, a slave node measures a value of a propagation time using one or more time stamps for each of one or more predetermined time units (such as one or more messages sent from the slave node to the master node). In this instance, the slave node can store and maintain the measured value corresponding to a predetermined number. The measured value is measured at each predetermined time unit. To measure the value in a current time unit, the slave node can measure the value of the propagation time according to operations S511, S512, S513, and S514.

In operation S511, the slave node stores a first time stamp in a first message and transmits the first message to the master node. The first time stamp is a transmission time of the first message. Specifically, to measure the value of the propagation time, the slave node needs information from four measurements (T1, T2, T3, and T4) as described above. For this, the slave node transmits the first message to the master node and the first time stamp corresponds to the transmission time T1 203 (illustrated in FIG. 2) of Equation 1.

In operation S512, the master node confirms a second time stamp, which is a receipt time of the first message. The second time stamp corresponds to the receipt time T2 204 of Equation 1.

In operation S513, the master node stores the first time stamp, the second time stamp, and a third time stamp in a second message and transmits the second message to the slave node. The third time stamp is a transmission time of the second message and corresponds to the transmission time T3 205 of Equation 1. Also, the first time stamp, the second time stamp, and the third time stamp are transmitted by transmitting the second message to the slave node.

In operation S514, the slave node confirms a fourth time stamp and measures the value of the propagation time using the first time stamp and the fourth time stamp. The fourth time stamp is a receipt time of the second message and corresponds to the receipt time T4 206 of Equation 1. For example, the value can be measured by the slave node according to Equation 4:

$${d}_{k} = \frac{( {T}_{2 , k} - {T}_{1 , k} ) + ( {T}_{4 , k} - {T}_{3 , k} )}{2} . \qquad [ Equation 4 ]$$

where dₖ is the measured value, T_{1,k} is the first time stamp, T_{2,k} is the second time stamp, T_{3,k} is the third time stamp, T_{4,k} is the fourth time stamp, and k refers to the k^{th} time unit of when the first time stamp, the second time stamp, the third time stamp, and the fourth time stamp are measured.

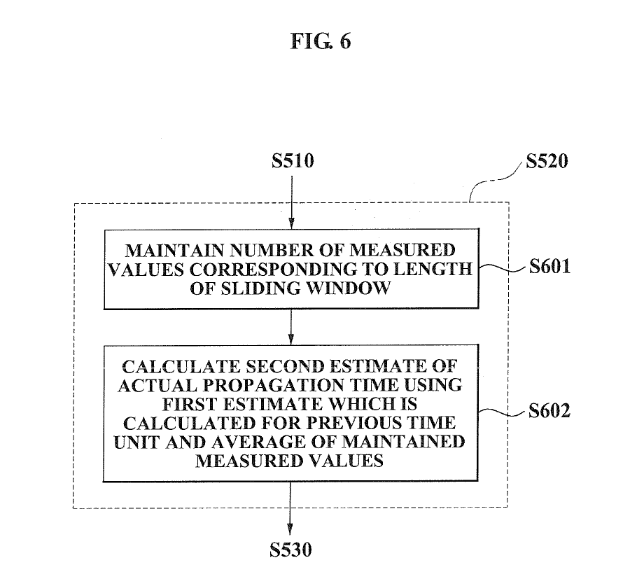

In operation S520, the slave node calculates an estimate of an actual propagation time using the measured values and a sliding window. A sliding window of length M can include a buffer that can store an M number of measured values. In this instance, the sliding window can maintain the M number of measured values that are most recently measured in the buffer. Also, the estimate of the actual propagation time can be calculated through the M number of measured values. Operation S520 will be described in greater detail with reference to FIG. 6.

In operation S530, the slave node computes an offset using a message transmission time corresponding to a sending of a message from the master node, a message receipt time corresponding to an arrival of the message at the slave node, and the estimate. For example, the slave node can compute the offset according to Equation 5:

Offset=T2−T1−D1 [Equation 5]

where T1 is the message transmission time, T2 is the message receipt time, and D1 is the estimate.

Specifically, when subtracting the message transmission time T1 from the message receipt time T2, a time until the message arrives at the slave node is obtained. Then, when the measured value of the propagation time, calculated using the sliding window, is excluded, a timing difference between the master node and the slave node is ascertained. Accordingly, a time synchronization between the master node and the slave node can be performed.

FIG. 6 is a flowchart illustrating a method of computing an estimate of an actual propagation time using a sliding window according to an embodiment of the present invention. As illustrated in FIG. 6, to calculate the estimate using the sliding window, operations S601 and S602 can be performed in operation S520 of FIG. 5.

In operation S601, the slave node maintains a number of measured values corresponding to a length of the sliding window. The measured values may be the most recently measured values. As described above with reference to FIG. 5, the sliding window of length M can include a buffer that can store M number of measured values (for example, M number of the most recently measured values). The M number of measured values can be maintained through the buffer.

In operation S602, the slave node calculates a second estimate of the actual propagation time as the estimate using a first estimate and an average of the maintained measured values. The first estimate is calculated for a previous time unit.

Specifically, the average of the subsequent measured values is obtained using the sliding window of length M. Also, using an average of a current measured value and an M−1 number of measured values, from among the average of the subsequent measured values and the measured value of the propagation time, the second estimate can be calculated according to Equation 6:

$${D}_{k} = {D}_{k - 1} + \frac{{d}_{k} - {d}_{k - M}}{M} \\ H ( z ) = \frac{1}{M} \cdot \frac{1 - {z}^{- M}}{1 - {z}^{- 1}} \qquad [ Equation 6 ]$$

where dₖ is the measured value in a k^{th} time unit, Dₖ is the estimate in the k^{th} time unit, M is the length of the sliding window, and H(z) is a transfer function for a difference equation for Dₖ.

In this instance, since a clock having a finite phase measurement granularity is used, a dₖ measurement error is generated. Accordingly, the estimate Dₖ can be obtained by calculating a difference between dₖ and d_{k-M}, and using Dₖ₋₁ and a ratio of the difference from M. In this instance, Dₖ₋₁ is a k−1^{th} estimate, and the ratio corresponds to an average of the M number of measured values that may be most recently measured.

A value greater than values of samples changing dₖ is selected as M, the length of the sliding window. For example, M may be 32 or greater in order to ensure more reliable results.

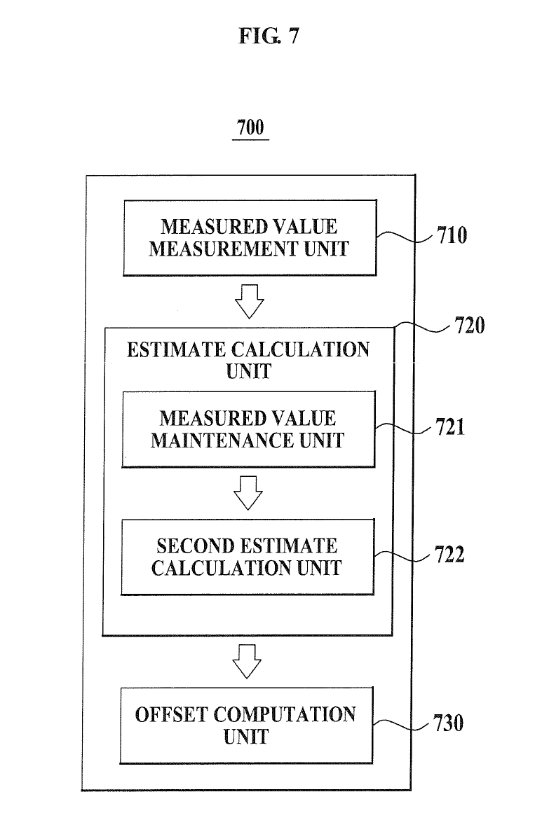

FIG. 7 is a block diagram illustrating a configuration of a slave node according to an embodiment of the present invention. As illustrated in FIG. 7, the slave node 700 includes a measured value measurement unit 710, an estimate calculation unit 720, and an offset computation unit 730.

The measured value measurement unit 710 measures a value of a propagation time to a master node using a time stamp at each predetermined time unit. To measure a value of a current time unit, the measured value measurement unit 710 can store a first time stamp in a first message and transmit the first message to the master node. The first time stamp is a transmission time of the first message.

Then, the master node can store the first time stamp, a second time stamp, and a third time stamp in a second message and can transmit the second message to the slave node 700. The second time stamp is a receipt time of the first message, and the third time stamp is a transmission time of the second message. The measured value measurement unit 710 confirms a fourth time stamp, which is a receipt time of the second message received by the slave node 700. The measured value measurement unit 710 can measure the value of the propagation time using the first time stamp and the fourth time stamp.

The estimate calculation unit 720 calculates an estimate of an actual propagation time using the measured value and a sliding window. In this instance, to calculate the estimate, the estimate calculation unit 720 includes a measured value maintenance unit 721 and a second estimate calculation unit 722.

The measured value maintenance unit 721 maintains a number of measured values corresponding to a length of the sliding window. The measured values may be those that are the most recently measured. As described above with reference to FIG. 6, the sliding window of length M can include a buffer that can store an M number of measured values. The M number of measured values can be maintained through the buffer.

The second estimate calculation unit 722 calculates a second estimate of the actual propagation time as the estimate using a first estimate and an average of the maintained measured values. The first estimate is calculated for a previous time unit. Specifically, the average of the subsequent measured values is obtained using the sliding window of length M. Also, the second estimate can be calculated as the estimate according to Equation 6 above using an average of a current measured value and an M−1 number of measured values from among the average of the subsequent measured values and the measured value of the propagation time.

Referring again to Equation 6, dₖ is a k^{th} measured value in the propagation time (i.e., the measured value in a k^{th} time unit). Dₖ is a k^{th} estimate in the actual propagation time, (i.e., the estimate in the k^{th} time unit). An estimate of a current time unit is the second estimate, and an estimate of the previous time unit is the first estimate. Also, M is a predetermined length of the sliding window.

In this instance, since a clock having a finite phase measurement granularity is used, a dₖ measurement error is generated. Accordingly, the estimate Dₖ can be obtained by calculating a difference between dₖ and d_{k-M}, and using Dₖ₋₁ and a ratio of the difference from M. In this instance, Dₖ₋₁ is a k−1^{th} estimate, and the ratio corresponds to an average of the M number of measured values that may be most recently measured.

A value greater than values of samples changing dₖ is selected as M, the length of the sliding window. For example, M may be 32 or greater in order to ensure more reliable results.

The offset computation unit 730 computes an offset using a message transmission time corresponding to a sending of a message from the master node, a message receipt time corresponding to an arrival of the message at the slave node, and the estimate.

As described above, according to aspects of the present invention, a time synchronization method and a slave node performing a time synchronization measure values of propagation time based on the time stamp at each predetermined time unit, and compute the offset from the master node using the average of the measured values and the sliding window to thereby improve jitter, wander, and a time synchronization function.

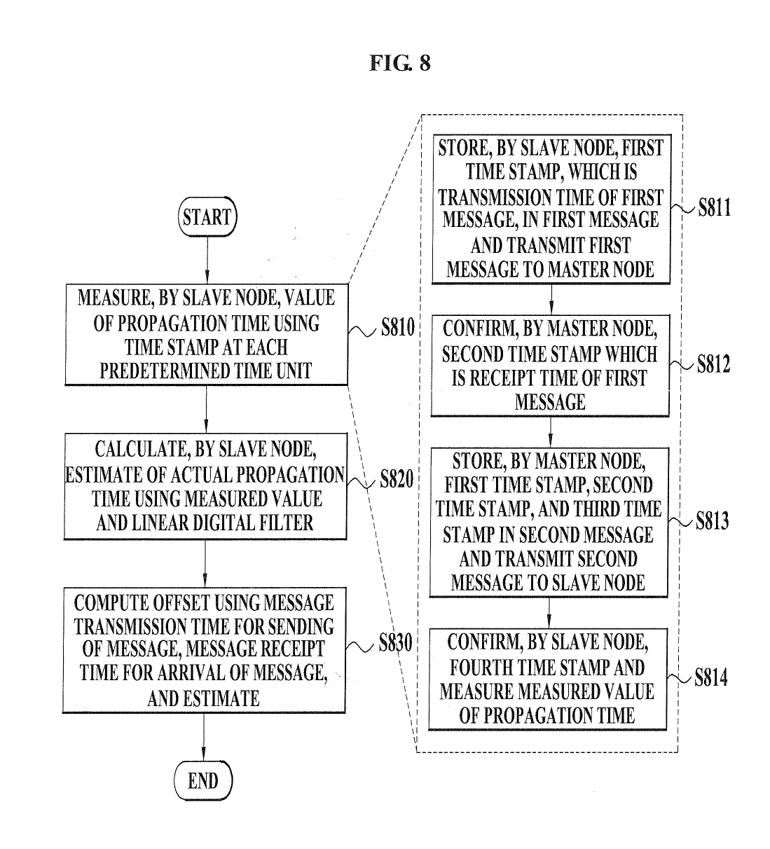

FIG. 8 is a flowchart illustrating a time synchronization method between nodes in a network according to another embodiment of the present invention. Referring to FIG. 8, in operation S810, a slave node measures a value of a propagation time to a master node using one or more time stamps for each of one or more predetermined time units (such as one or more messages sent from the slave node to the master node). In this instance, to measure the measured value for a current time unit, the slave node can measure the value of the propagation time according to operations S811, S812, S813, and S814.

In operation S811, the slave node stores a first time stamp in a first message and transmits the first message to the master node. The first time stamp is a transmission time of the first message. Specifically, to measure the value of the propagation time, the slave node needs information from four measurements as described above (T1, T2, T3, and T4). For this, the slave node transmits the first message to the master node and the first time stamp corresponds to T_{1,k} of Equation 4 above.

In operation S812, the master node confirms a second time stamp, which is a receipt time of the first message. The second time stamp corresponds to T_{2,k} of Equation 4.

In operation S813, the master node stores the first time stamp, the second time stamp, and a third time stamp in a second message and transmits the second message to the slave node. The third time stamp is a transmission time of the second message and corresponds to T_{3,k} of Equation 4.

In operation S814, the slave node confirms a fourth time stamp and measures the value of the propagation time using the first time stamp and the fourth time stamp. The fourth time stamp is a receipt time of the second message and corresponds to T_{4,k} of Equation 4. Accordingly, the slave node can measure the value of the propagation time in a k^{th} time unit using, for example, Equation 4.

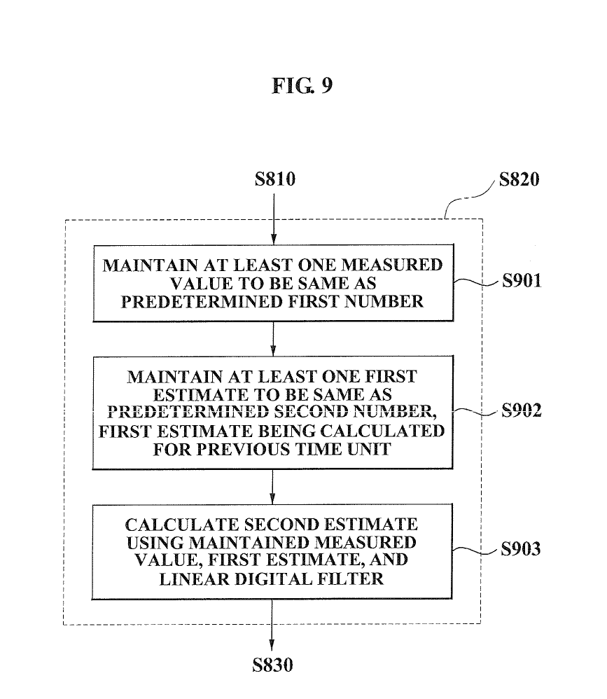

In operation S820, the slave node calculates an estimate of an actual propagation time using the measured value and a linear digital filter. Operation S820 is described in greater detail with reference to FIG. 9.

In operation S830, the slave node computes an offset using a message transmission time corresponding to a sending of a message from the master node, a message receipt time corresponding to an arrival of the message at the slave node, and the estimate. For example, the slave node computes the offset according to Equation 5.

Specifically, referring to Equation 5, when subtracting the message transmission time from the message receipt time, a time until the message arrives at the slave node is obtained. Then, when the measured value of the propagation time, calculated using the linear digital filter, is excluded, a timing difference between the master node and the slave node is ascertained. Accordingly, a time synchronization between the master node and the slave node can be performed.

FIG. 9 is a flowchart illustrating a method of computing an estimate of an actual propagation time using a linear digital filter according to another embodiment of the present invention. As illustrated in FIG. 9, operations S901, S902, and S903 can be performed in operation S820 of FIG. 8.

In operation S901, the slave node maintains at least one measured value equal to a predetermined first number. The first number can vary according to a number of measured values to be maintained.

In operation S902, the slave node maintains at least one first estimate to be equal to a predetermined second number. The first estimate is calculated for a previous time unit, and the second number can vary according to a number of the first estimate to be maintained.

in operation S903, the slave node calculates a second estimate using the maintained measured value, the first estimate, and the linear digital filter. The second estimate is the estimate of the actual propagation time. The linear digital filter provides the maintained measured values and the first estimate with a plurality of filter coefficients and calculates a sum as the second estimate. The sum corresponds to a sum of the maintained measured value and the first estimate where the plurality of filter coefficients is provided.

To average subsequent measured values of the propagation time using a general linear digital filter, a sequence of the measured values is inputted to the general linear digital filter (represented as Equation 7 below), and a second estimate Dₖ can therefore be calculated according to Equation 7:

$$\begin{matrix}{D}_{k} = {a}_{1} {D}_{k - 1} + {a}_{2} {D}_{k - 2} + ⋯ + \\ {a}_{n} {D}_{k - n} + {b}_{0} {d}_{k} + {b}_{1} {d}_{k - 1} + ⋯ + {b}_{m} {d}_{k - m}\end{matrix} \\ H ( z ) = \frac{{b}_{0} + {b}_{1} {z}^{- 1} + ⋯ + {b}_{m} {z}^{- m}}{1 - {a}_{1} {z}^{- 1} - {a}_{2} {z}^{- 2} - ⋯ - {a}_{n} {z}^{- n}} . \qquad [ Equation 7 ]$$

where dₖ is the measured value in a k^{th} time unit, Dₖ is the second estimate in the k^{th} time unit, H(z) is a filter transfer function, aᵢ(1<i<n) and bⱼ(0<j<m) are the plurality of filter coefficients, n is the first number, and m is the second number.

So that an output of the linear digital filter converges to the actual propagation time, the plurality of filter coefficients satisfies Equation 8:

a₁+a₂+ . . . +aₙ+b₀+b₁+ . . . bₘ=1

Here, a bandwidth of the linear digital filter is smaller than a discrete frequency of a variation of dₖ.

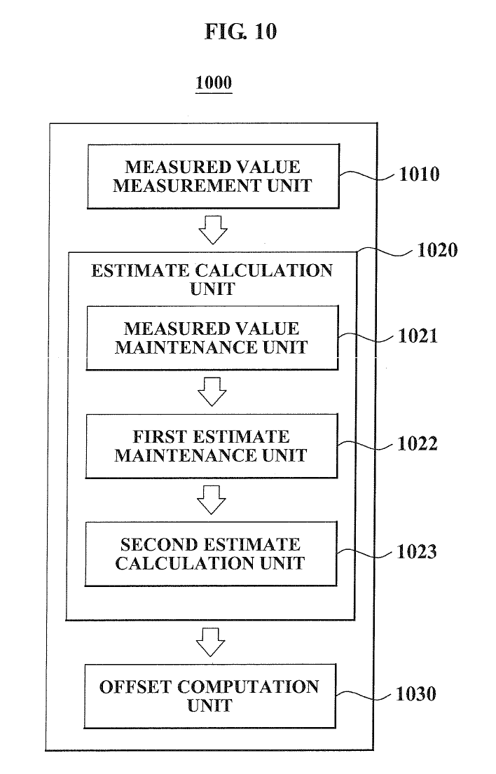

FIG. 10 is a block diagram illustrating a configuration of a slave node according to another embodiment of the present invention. As illustrated in FIG. 10, a slave node 1000 includes a measured value measurement unit 1010, an estimate calculation unit 1020, and an offset computation unit 1030.

The measured value measurement unit 1010 measures a value of a propagation time to a master node using a time stamp at each predetermined time unit. To measure a value of a current time unit, the measured value measurement unit 1010 can store a first time stamp in a first message and transmit the first message to the master node. The first time stamp is a transmission time of the first message.

Then, the master node can store the first time stamp, a second time stamp, and a third time stamp in a second message and can transmit the second message to the slave node 1000. The second time stamp is a receipt time of the first message, and the third time stamp is a transmission time of the second message. The measured value measurement unit 1010 confirms a fourth time stamp which is a receipt time of the second message received by the slave node 1000. The measured value measurement unit 1010 can measure the value of the propagation time using the first time stamp and the fourth time stamp.

The estimate calculation unit 1020 calculates an estimate of an actual propagation time using the measured value and a sliding window. In this instance, to calculate the estimate, the estimate calculation unit 1020 includes a measured value maintenance unit 1021, a first estimate maintenance unit 1022, and a second estimate calculation unit 1023.

The measured value maintenance unit 1021 maintains at least one measured value to be equal to a predetermined first number. The first number can vary according to a number of measured values to be maintained.

The first estimate maintenance unit 1022 maintains at least one first estimate to be equal to a predetermined second number. The first estimate is calculated for a previous time unit, and the second number can vary according to a number of first estimates to be maintained.

The second estimate calculation unit 1023 calculates a second estimate using the maintained measured value, the first estimate, and the linear digital filter. The second estimate is the estimate of the actual propagation time. The linear digital filter provides the maintained measured values and the first estimate with a plurality of filter coefficients and calculates a sum as the second estimate. The sum corresponds to a sum of the maintained measured value and the first estimate where the plurality of filter coefficients is provided. Specifically, the second estimate calculation unit 1023 may calculate the second estimate according to Equation 7 provided above.

The offset computation unit 1030 computes an offset using a message transmission time corresponding to a sending of a message from the master node, a message receipt time corresponding to an arrival of the message at the slave node, and the estimate. In this instance, the offset computation unit 1030 can compute the offset as according to Equation 5 provided above.

Specifically, when subtracting the message transmission time from the message receipt time, a time until the message arrives at the slave node is obtained. Then, when the estimate that is calculated using the linear digital filter is excluded, a timing difference between the master node and the slave node is ascertained. Accordingly, a time synchronization between the master node and the slave node can be performed.

As described above, according to aspects of the present invention, a time synchronization method between nodes in a network and an apparatus for implementing the same measure values of a propagation time based on a time stamp at each predetermined time unit, compute an offset from the master node using an average of the measured values and a linear digital filter, and can thereby improve jitter, wander, and a time synchronization function.

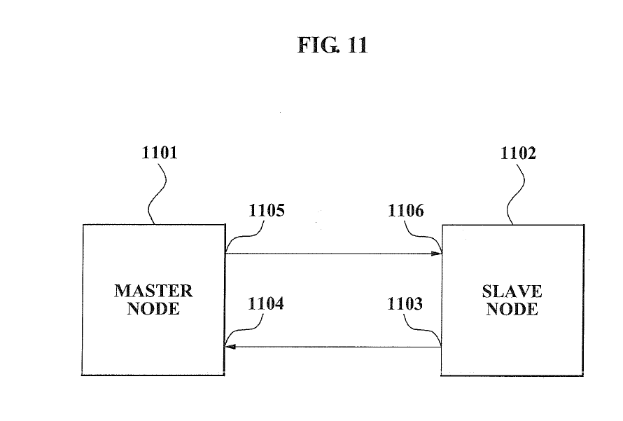

FIG. 11 is a diagram illustrating an example of a bidirectional method for a time synchronization according to an embodiment of the present invention. Referring to FIG. 11, a master node 1101 transmits a first message to all slave nodes of the master node 1101. The master node 1101 does not transmit the first message to a master node of the master node 1101. The first message includes a transmission time T1 of the first message. Each of the slave nodes confirm a receipt time T2 of the first message when the slaves nodes receive the first message. When a slave node 1102 knows a propagation time with the master node 1101, an offset between the slave node 1102 and the master node 1101 can be computed, as describe with reference to Equation 5 provided above. Accordingly, the time synchronization can be performed.

To measure the propagation time, the slave node 1102 transmits a second message to the master node 1101 in a k time unit. The second message can be transmitted including a transmission time T₁ₖ 1103 corresponding to a time stamp when the second message is transmitted.

When receiving the second message, the master node 1101 confirms a receipt time T₂ₖ 1104 corresponding to a time stamp when the second message is received. Then, the master node 1101 transmits a third message to a slave node 1102 in response to the second message. The third message can include the transmission time T₁ₖ 1103 of the second message, the receipt time T₂ₖ 1104 of the second message, and a transmission time T₃ₖ 1105 of the third message. The transmission time T₃ₖ of the third message 1105 is a time stamp when the third message is transmitted.

The slave node 1102 receiving the third message confirms a receipt time T₄ₖ 1106 corresponding to a time stamp when the third message is received. Also, the slave node 1102 can confirm the transmission time T₁ₖ 1103 of the second message, the receipt time T₂ₖ 1104 of the second message, and the transmission time T₃ₖ 1105 of the third message, which are included in the third message.

As described above, the slave node 1102 can ascertain the transmission time T₁ₖ 1103 of the second message, the receipt time T₂ₖ 1104 of the second message, the transmission time T₃ₖ 1105 of the third message, and the receipt time T₄ₖ 1106 of the third message in the k time unit. Also, the slave node 1102 can measure a value dₖ of a propagation delay for the k time unit according to Equation 4 provided above.

Then, an estimate Dₖ of an actual propagation delay can be obtained through a plurality of measured values using a sliding window of length M or a linear digital filter. Specifically, when using the sliding window of length M, the slave node 1102 can calculate the estimate Dₖ using an estimate Dₖ₋₁ of a previous time unit and an average of an M number of measured values, such as in Equation 6 provided above. Alternatively, when using the linear digital filter, the slave node 1102 can compute the estimate Dₖ using an m number of measured values, an n number of estimates, and a filter coefficient (such as in Equation 7 provided above). The n number of estimates may be the most recently calculated estimates.

Also, the offset for the k time unit can be computed using the estimate Dₖ. Accordingly, as described above, the time synchronization between the master node 1101 and the slave node 1102 can be performed. A subsequent time synchronization in a network is performed through repeating operations described above.

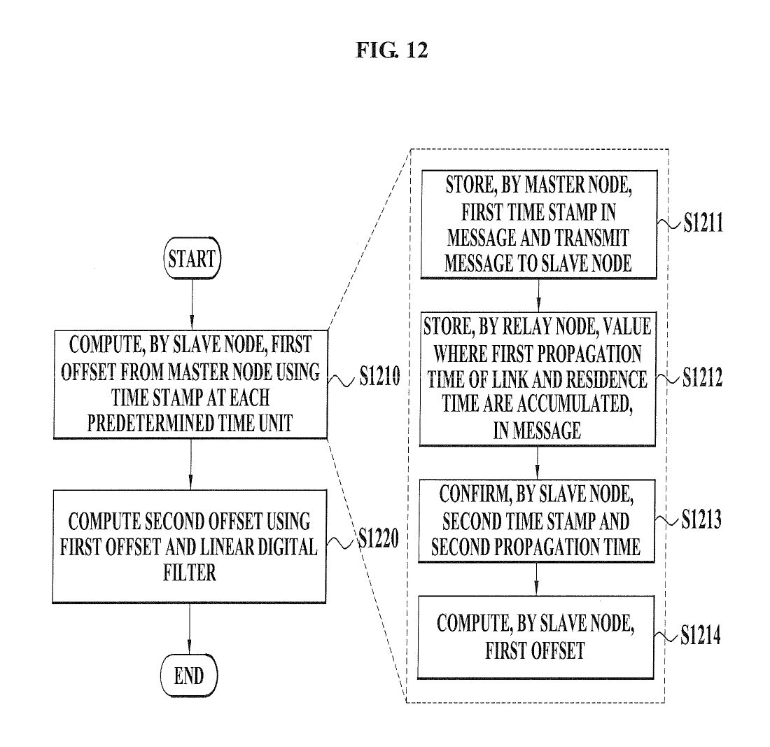

The bidirectional time synchronization method using the sliding window or the linear digital filter has been described with reference to FIGS. 5 through 11. Hereinafter, a unidirectional time synchronization method that can compute an offset between the master node and the slave node by a one-time message transmission is described in detail with reference to FIGS. 12 through 14.

FIG. 12 is a flowchart illustrating a unidirectional time synchronization method between nodes in a network according to an embodiment of the present invention. Referring to FIG. 12, first, in operation S1210, a slave node computes a first offset from a master node using a time stamp at each predetermined time unit. As illustrated in FIG. 12, operation S1210 can be performed including operations S1211, S1212, S1213, and S1214.

In operation S1211, the master node stores a first time stamp in a message and transmits the message to the slave node. The first time stamp is a transmission time of the message.

In operation S1212, a relay node stores, in the message, a value accumulating a first propagation time of a link and a residence time in the relay node. The link receives the message.

In operation S1213, the slave node confirms a second time stamp and a second propagation time of a link between a last relay node and the slave node. The second time stamp is a receipt time of the message.

In operation S1214, the slave node computes the first offset using the first time stamp, the second time stamp, the accumulated value, and the second propagation time. The slave node can compute the first offset according to Equation 9:

First offset=T2−T1−R1D1. [Equation 9]

where T2 is the second time stamp, T1 is the first time stamp, R1 is the accumulated value, and D1 is the second propagation time.

in operation S1220, the slave node computes a second offset using the first offset and a linear digital filter. It is understood that the slave node can compute the second offset using the first offset and a predetermined number of offsets that are measured for previous time units. The second offset may be computed according to Equation 10:

$$\begin{matrix}{y}_{k} = {a}_{1} {y}_{k - 1} + {a}_{2} {y}_{k - 2} + ⋯ + {a}_{n} {y}_{k - n} + \\ {b}_{0} {u}_{k} + {b}_{1} {u}_{k - 1} + ⋯ + {b}_{m} {u}_{k - m}\end{matrix} \\ H ( z ) = \frac{{b}_{0} + {b}_{1} {z}^{- 1} + ⋯ + {b}_{m} {z}^{- m}}{1 - {a}_{1} {z}^{- 1} - {a}_{2} {z}^{- 2} - ⋯ - {a}_{n} {z}^{- n}} . \qquad [ Equation 10 ]$$

where uₖ is the first offset, yₖ is the second offset, aᵢ(1<i<n) and bⱼ(0<j<m) are a filter coefficient of the linear digital filter, and H(z) is a filter transfer function.

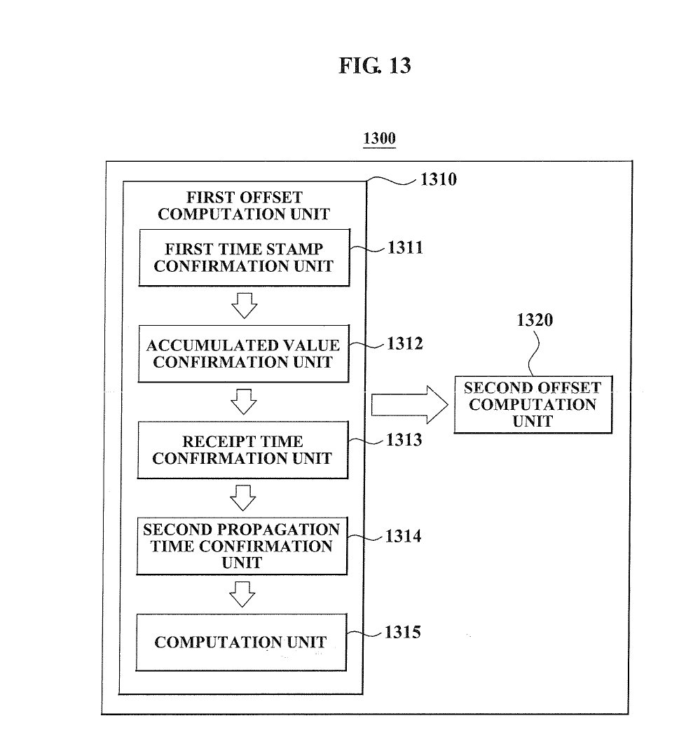

FIG. 13 is a block diagram illustrating a configuration of a slave node according to an embodiment of the present invention. As illustrated in FIG. 13, the slave node 1300 includes a first offset computation unit 1310 and a second offset computation unit 1320.

The first offset computation unit 1310 computes a first offset from a master node using a time stamp at each predetermined time unit. To compute the first offset, the first offset computation unit 1310 includes a first time stamp confirmation unit 1311, an accumulated value confirmation unit 1312, a receipt time confirmation unit 1313, a second propagation time confirmation unit 1314, and a computation unit 1315. The first time stamp confirmation unit 1311 confirms a first time stamp, which is a transmission time of a message received from the master node. The accumulated value confirmation unit 1312 confirms an accumulated value of a first propagation time and a residence time in the message. The receipt time confirmation unit 1313 confirms a second time stamp, which is a receipt time of the message. The second propagation time confirmation unit 1314 confirms a second propagation time of a link between a last relay node and the slave node. The computation unit 1315 computes the first offset using the first time stamp, the second time stamp, the accumulated value, and the second propagation time.

The first propagation time can be a propagation time of a link receiving the message in a relay node. The residence time can be a residence time of the message in the relay node. Furthermore, the computation unit 1315 can compute the first offset according to Equation 9 provided above.

The second offset computation unit 1320 computes a second offset using the first offset and a linear digital filter. The second offset computation unit 1320 can compute the second offset according to Equation 10 provided above using the first offset and a predetermined number of offsets. The predetermined number of offsets are each computed for one or more previous time units.

Thus, according to aspects of the present invention, in a system for measuring a propagation time in a unidirectional method, a time synchronization method between nodes in a network and an apparatus for implementing the same compute a first offset from a master node at each predetermined time unit, compute a second offset (i.e., an offset of a current time unit) via a linear digital filter that has the one or more first offsets, computed for one or more previous time units, as an input value, and can thereby improve jitter, wander, and a time synchronization function as well as consider a residence time in a relay device.

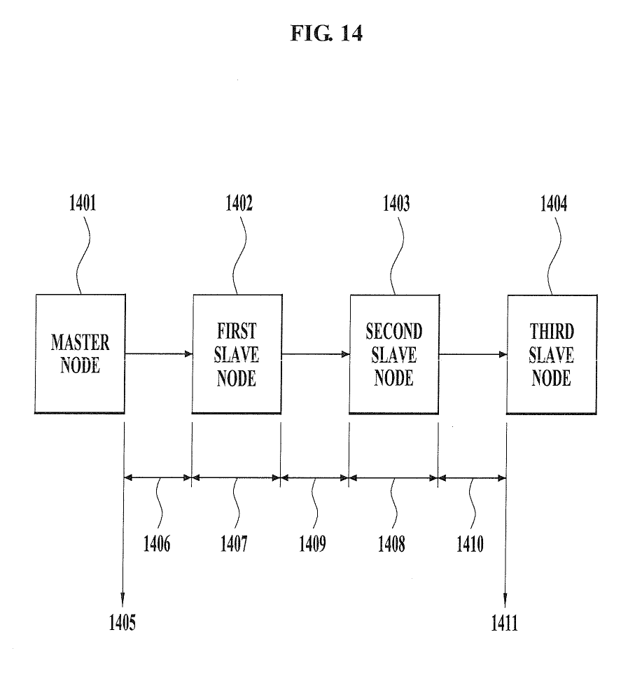

FIG. 14 is a diagram illustrating an example of a unidirectional method for a time synchronization according to an embodiment of the present invention. Referring to FIG. 14, a master node 1401 transmits a message to a third slave node 1404 via a first slave node 1402 and a second slave node 1403 to perform a time synchronization in a k time unit. The message includes a transmission time T₁ₖ 1405 of the message. The first slave node 1402 confirms a propagation time 1406 of a link and a residence time 1407 in the first slave node 1402. Then, the first slave node 1402 accumulates the propagation time 1406 and the residence time 1407 in the message and transmits the message to a subsequent node (i.e., the second slave node 1403). In this instance, the link receives the message, and the subsequent node (i.e., the second slave node 1403) confirms a propagation time 1409 of the link and a residence time 1408 in the second slave node 1403. Then, the second slave node 1403 accumulates the propagation time 1409 and the residence time 1408 in the message and transmits the message to a subsequent node (i.e., the third slave node 1404). The message includes a value R₁ₖ where the propagation time 1406, the residence time 1407, the residence time 1408, and the propagation time 1409 are accumulated.

The subsequent node of the second slave node 1403 (i.e., a destination) is the third slave node 1404. The third slave node 1404 confirms a propagation time D₁ₖ 1410 of the link with the second slave node 1403 (i.e., a last relay node). Also, the third slave node 1404 confirms a receipt time T₂ₖ 1411 when receiving the message.

The third slave node 1404 can compute the first offset uₖ using the parameters according to Equation 9 provided above. The third slave node 1404 maintains an m number of first offsets uₖ in a most recently computed order. The first offset uₖ is computed for the k time unit. Also, the third slave node 1404 maintains an n number of second offsets. The second offset is computed for a previous time unit.

Specifically, the third slave node 1404 can compute the second offset (i.e., an offset in the k time unit) according to Equation 10. A time synchronization between the master node 1401 and the third slave node 1404 is performed via the second offset. A time synchronization with respect to other slave nodes can be performed through the same operations. Accordingly, the time synchronization of an entire network can be performed.

The above-described embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc., including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to aspects of the present invention, a time synchronization method between nodes in a network and an apparatus for implementing the same measure values of propagation time based on a time stamp at each predetermined time unit, compute an offset from a master node using an average of the measured values and a sliding window, and can thereby improve jitter, wander, and a time synchronization function.

According to another aspect of the present invention, a time synchronization method between nodes in a network and an apparatus for implementing the same measure values of propagation time based on a time stamp at each predetermined time unit, compute an offset from a master node using an average of the measured values and a linear digital filter, and can thereby improve jitter, wander, and a time synchronization function.

According to another aspect of the present invention, a time synchronization method between nodes in a network and an apparatus for implementing the same compute one or more first offsets from a master node at each predetermined time unit, compute a second offset, that is, an offset of a current time unit, via a linear digital filter that has the one or more first offsets computed for a previous time unit as an input value, and can thereby improve jitter, wander, and a time synchronization function as well as consider a residence time in an intermediate relay device.

Although a few embodiments of the present invention have been shown and described, it would be appreciated by those skilled in the art that changes may be made in this embodiment without departing from the principles and spirit of the invention, the scope of which is defined by the claims and their equivalents.

What is claimed is:

1. A time synchronization method between nodes in a network, the time synchronization method comprising:
measuring a value of a propagation time from a slave node to a master node using time stamps for each of one or more messages sent from the slave node to the master node;
calculating an estimate of an actual propagation time using the one or more measured values and a sliding window; and
computing an offset using a message transmission time corresponding to a sending of a message from the master node, a message receipt time corresponding to an arrival of the message at the slave node, and the estimate of the actual propagation time.

2. The time synchronization method as claimed in claim 1, wherein the calculating of the estimate comprises:
maintaining a number of the one or more measured values corresponding to a length of the sliding window.

3. The time synchronization method as claimed in claim 2, wherein the calculating of the estimate further comprises:
calculating the estimate of the actual propagation time using a current measured value and a first estimate that is calculated from an average of the maintained measured values excluding the current measured value.

4. The time synchronization method as claimed in claim 2, wherein the maintaining of the number of the measured values comprises maintaining a number of most recently measured values corresponding to the length of the sliding window.

5. The time synchronization method as claimed in claim 3, wherein the calculating of the estimate using the current measured value and the first estimate comprises calculating the estimate according to an equation:
$${D}_{k} = {D}_{k - 1} + \frac{{d}_{k} - {d}_{k - M}}{M}$$
where dₖ is the measured value corresponding to a k^{th} message, Dₖ is the estimate, Dₖ₋₁ is the first estimate, and M is the length of the sliding window.

6. The time synchronization method as claimed in claim 5, wherein the calculating of the estimate using the current measured value and the first estimate further comprises calculating the estimate according to another equation:
$$H ( z ) = \frac{1}{M} \cdot \frac{1 - {z}^{- M}}{1 - {z}^{- 1}}$$
where H(z) is a transfer function for a difference equation for Dₖ.

7. The time synchronization method as claimed in claim 1, wherein the measuring of the value comprises:
storing a first time stamp corresponding to a transmission time of a first message in the first message and transmitting the first message from the slave node to the master node;
confirming a second time stamp corresponding to a receipt time of the first message received by the master node;
storing the first time stamp, the second time stamp, and a third time stamp corresponding to a transmission time of a second message in the second message and transmitting the second message from the master node to the slave node;
confirming a fourth time stamp corresponding to a receipt time of the second message received by the slave node; and
measuring the value of the propagation time using the first time stamp and the fourth time stamp.

8. The time synchronization method as claimed in claim 7, wherein the measuring of the value of the propagation time using the first time stamp and the fourth time stamp comprises measuring the value of the propagation time according to an equation:
$${d}_{k} = \frac{( {T}_{2 , k} - {T}_{1 , k} ) + ( {T}_{4 , k} - {T}_{3 , k} )}{2}$$
where dₖ is the measured value, T_{1,k} is the first time stamp, T_{2,k} is the second time stamp, T_{3,k} is the third time stamp, and T_{4,k} is the fourth time stamp.

9. The time synchronization method as claimed in claim 1, wherein the computing of the offset comprises computing the offset according to an equation:
Offset=T2−T1−D1
where T1 is the message transmission time, T2 is the message receipt time, and D1 is the estimate.

10. A time synchronization method between nodes in a network, the time synchronization method comprising:
measuring a value of a propagation time from a slave node to a master node using time stamps for each of one or more messages sent from the slave node to the master node;
calculating an estimate of an actual propagation time using the one or more measured values and a linear digital filter; and
computing an offset using a message transmission time corresponding to a sending of a message from the master node, a message receipt time corresponding to an arrival of the message at the slave node, and the estimate of the actual propagation time.

11. The time synchronization method as claimed in claim 10, wherein the calculating of the estimate comprises:
maintaining an n number of measured values;
maintaining an m number of first estimates, each first estimate being calculated from previous measured values; and
calculating the estimate of the actual propagation time using the n number of measured values, the m number of first estimates, and the linear digital filter,
wherein the linear digital filter provides the n number of measured values and the m number of first estimates with a plurality of filter coefficients, and calculates a sum as the estimate, the sum corresponding to a sum of the n number of measured values and the m number of first estimates where the plurality of filter coefficients are provided.

12. The time synchronization method as claimed in claim 11, wherein the calculating of the estimate using the n number of measured values, the m number of first estimates, and the linear digital filter comprises calculating the estimate according to an equation:
Dₖ=a₁Dₖ₋₁+a₂Dₖ₋₂+ . . . +aₙDₖ₋ₙ+b₀dₖ+b₁dₖ₋₁+ . . . +bₘdₖ₋ₘ
where dₖ is the measured value corresponding to a k^{th} message, Dₖ is the estimate, Dₖ₋₁ is one of the first estimates, and aᵢ(1<i<n) and bⱼ(0<j<m) are the plurality of filter coefficients.

13. The time synchronization method as claimed in claim 12, wherein the calculating of the estimate using the n number of measured values, the m number of first estimates, and the linear digital filter further comprises calculating the estimate according to another equation:
$$H ( z ) = \frac{{b}_{0} + {b}_{1} {z}^{- 1} + ⋯ + {b}_{m} {z}^{- m}}{1 - {a}_{1} {z}^{- 1} - {a}_{2} {z}^{- 2} - ⋯ - {a}_{n} {z}^{- n}}$$
where H(z) is a filter transfer function.

14. The time synchronization method as claimed in claim 12, wherein aᵢ(1<i<n) and bⱼ(0<j<m) satisfy another equation:
a₁+a₂+ . . . +aₙ+b₀+b₁+ . . . +bₘ=1.

15. The time synchronization method as claimed in claim 10, wherein the measuring of the value comprises:
storing a first time stamp corresponding to a transmission time of a first message in the first message and transmitting the first message from the slave node to the master node;
confirming a second time stamp corresponding to a receipt time of the first message received by the master node;
storing the first time stamp, the second time stamp, and a third time stamp corresponding to a transmission time of a second message in the second message and transmitting the second message from the master node to the slave node;
confirming a fourth time stamp corresponding to a receipt time of the second message received by the slave node; and
measuring the value of the propagation time using the first time stamp and the fourth time stamp.

16. The time synchronization method as claimed in claim 15, wherein the measuring of the value using the first time stamp and the fourth time stamp comprises measuring the value according to an equation:
$${d}_{k} = \frac{( {T}_{2 , k} - {T}_{1 , k} ) + ( {T}_{4 , k} - {T}_{3 , k} )}{2}$$
where dₖ is the measured value, T_{1,k} is the first time stamp, T_{2,k} is the second time stamp, T_{3,k} is the third time stamp, T_{4,k} is the fourth time stamp, and k identifies a message, of the one or more messages, for when the first time stamp, the second time stamp, the third time stamp, and the fourth time stamp are measured.

17. The time synchronization method as claimed in claim 10, wherein the computing of the offset comprises computing the offset according to an equation:
Offset=T2−T1−D1
where T1 is the message transmission time, T2 is the message receipt time, and D1 is the estimate.

18. A time synchronization method between nodes in a network, the time synchronization method comprising:
computing a first offset from a master node using one or more time stamps for each of one or more messages sent from the master node to a slave node; and
computing a second offset using the one or more first offsets and a linear digital filter.

19. The time synchronization method as claimed in claim 18, wherein the computing of the first offset comprises:
storing a first time stamp corresponding to a transmission time of a message in the first message and transmitting the message from the master node to the slave node;
storing, in the message, a value accumulating a first propagation time from the master node to a relay node and a residence time in the relay node, the relay node receiving the message;
confirming a second time stamp corresponding to a receipt time of the message received by the slave node, and a second propagation time from a last relay node to the slave node; and
computing the first offset using the first time stamp, the second time stamp, the accumulated value, and the second propagation time.

20. The time synchronization method as claimed in claim 19, wherein the computing of the first offset using the first time stamp, the second time stamp, the accumulated value, and the second propagation time comprises computing the first offset according to an equation:
First offset=T2−T1−R1−D1
where T2 is the second time stamp, T1 is the first time stamp, R1 is the accumulated value, and D1 is the second propagation time.

21. The time synchronization method as claimed in claim 18, wherein the computing of the second offset comprises computing the second offset using the one or more first offsets according to an equation:
yₖ=a₁yₖ₋₁+a₂yₖ₋₂+ . . . +aₙyₖ₋ₙ+b₀uₖ+b₁uₖ₋₁+ . . . +bₘuₖ₋ₘ
where uₖ is one of the first offsets, yₖ is the second offset, and aᵢ(1<i<n) and bⱼ(0<j<m) are filter coefficients of the linear digital filter.

22. The time synchronization method as claimed in claim 21, wherein the computing of the second offset further comprises computing the second offset according to another equation:
$$H ( z ) = \frac{{b}_{0} + {b}_{1} {z}^{- 1} + ⋯ + {b}_{m} {z}^{- m}}{1 - {a}_{1} {z}^{- 1} - {a}_{2} {z}^{- 2} - ⋯ - {a}_{n} {z}^{- n}}$$
where H(z) is a filter transfer function.

23. A computer-readable recording medium encoded with the method of claim 1 and implemented by a computer.

24. A computer-readable recording medium encoded with the method of claim 10 and implemented by a computer.

25. A computer-readable recording medium encoded with the method of claim 18 and implemented by a computer.

26. An apparatus for performing a time synchronization between nodes in a network, the apparatus comprising:
a measured value measurement unit to measure a value of propagation time from a slave node to a master node using time stamps for each of one or more messages sent from the slave node to the master node;
an estimate calculation unit to calculate an estimate of an actual propagation time using the one or more measured values and a sliding window; and
an offset computation unit to compute an offset using a message transmission time corresponding to a sending of a message from the master node, a message receipt time corresponding to an arrival of the message at the slave node, and the estimate of the actual propagation time.

27. The apparatus as claimed in claim 26, wherein the estimate calculation unit comprises:
a measured value maintenance unit to maintain a number of the one or more measured values corresponding to a length of the sliding window; and
a second estimate calculation unit to calculate a second estimate of the actual propagation time as the estimate using a current measured value and a first estimate that is calculated from an average of the maintained measured values excluding the current measured value.

28. The apparatus as claimed in claim 27, wherein the measured value maintenance unit maintains a number of the most recently measured values corresponding to the length of the sliding window.

29. The apparatus as claimed in claim 19, wherein the second estimate calculation unit calculates the second estimate according to equations:
$${D}_{k} = {D}_{k - 1} + \frac{{d}_{k} - {d}_{k - M}}{M}$$
$$H ( z ) = \frac{1}{M} \cdot \frac{1 - {z}^{- M}}{1 - {z}^{- 1}}$$
where dₖ is the measured value corresponding to a k^{th} message, Dₖ is the estimate, Dₖ₋₁ is the first estimate, M is the length of the sliding window, and H(z) is a transfer function for a difference equation for Dₖ.

30. The apparatus as claimed in claim 26, wherein the measured value measurement unit:
stores a first time stamp corresponding to a transmission time of a first message in the first message and transmits the first message from the slave node to the master node;
receives a second message storing the first time stamp, a second time stamp corresponding to a receipt time of the first message by the master node, and a third time stamp corresponding to a transmission time of the second message from the master node to the slave node;
confirms a fourth time stamp corresponding to a receipt time of the second message received by the slave node; and
measures the value of the propagation time using the first time stamp and the fourth time stamp.

31. The apparatus as claimed in claim 26, wherein the apparatus is the slave node.

32. An apparatus for performing a time synchronization between nodes in a network, the apparatus comprising:
a measured value measurement unit to measure a value of a propagation time from a slave node to a master node using time stamps for each of one or more messages sent from the slave node to the master node;
an estimate calculation unit to calculate an estimate of an actual propagation time using the one or more measured values and a linear digital filter; and
an offset computation unit to compute an offset using a message transmission time corresponding to a sending of a message from the master node, a message receipt time corresponding to an arrival of the message at a slave node, and the estimate of the actual propagation time.

33. The apparatus as claimed in claim 32, wherein the estimate calculation unit comprises:
a measured value maintenance unit to maintain an n number of measured values,
a first estimate maintenance unit to maintain an m number of first estimates, each first estimate being calculated from previous measured values; and
a second estimate calculation unit to calculate a second estimate as the estimate of the actual propagation time using the n number of measured values, the m number of first estimates, and the linear digital filter,
wherein the linear digital filter provides the n number of measured values and the m number of first estimates with a plurality of filter coefficients, and calculates a sum as the second estimate, the sum corresponding to a sum of the n number of measured values and the m number of first estimates where the plurality of filter coefficients are provided.

34. The apparatus as claimed in claim 33, wherein the second estimate calculation unit calculates the second estimate according to equations:
$$\begin{matrix}{D}_{k} = {a}_{1} {D}_{k - 1} + {a}_{2} {D}_{k - 2} + ⋯ + \\ {a}_{n} {D}_{k - n} + {b}_{0} {d}_{k} + {b}_{1} {d}_{k - 1} + ⋯ + {b}_{m} {d}_{k - m}\end{matrix}$$
$$H ( z ) = \frac{{b}_{0} + {b}_{1} {z}^{- 1} + ⋯ + {b}_{m} {z}^{- m}}{1 - {a}_{1} {z}^{- 1} - {a}_{2} {z}^{- 2} - ⋯ - {a}_{n} {z}^{- n}}$$
where dₖ is the measured value corresponding to a k^{th} message, Dₖ is the estimate, H(z) is a filter transfer function, and aᵢ(1<i<n) and bⱼ(0<j<m) are the plurality of filter coefficients.

35. The apparatus as claimed in claim 34, wherein the aᵢ(1<i<n) and the bⱼ(0<j<m) satisfy another equation:
a₁+a₂+ . . . +aₙ+b₀+b₁+ . . . +bₘ=1

36. The apparatus as claimed in claim 32, wherein the measured value measurement unit:
stores a first time stamp corresponding to a transmission time of a first message in the first message and transmits the first message from the slave node to the master node;
receives a second message storing the first time stamp, a second time stamp corresponding to a receipt time of the first message by the master node, and a third time stamp corresponding to a transmission time of the second message from the master node to the slave node;
confirms a fourth time stamp corresponding to a receipt time of the second message received by the slave node; and
measures the value of the propagation time using the first time stamp and the fourth time stamp.

37. The apparatus as claimed in claim 32, wherein the apparatus is the slave node.

38. An apparatus for performing a time synchronization between nodes in a network, the apparatus comprising:
a first offset computation unit to compute a first offset from a master node using one or more time stamps for each of one or more messages sent from the master node to a slave node; and
a second offset computation unit to compute a second offset using the one or more first offsets and a linear digital filter.

39. The apparatus as claimed in claim 38, wherein the first offset computation unit comprises:
a first time stamp confirmation unit to confirm a first time stamp corresponding to a transmission time of a message by receiving the message from the master node;
an accumulated value confirmation unit to confirm an accumulated value, stored in the message, of a first propagation time of the message from the master node to a relay node and a residence time of the message in the relay node;
a receipt time confirmation unit to confirm a second time stamp corresponding to a receipt time of the message received by the slave node;
a second propagation time confirmation unit to confirm a second propagation time of the message from a last relay node to the slave node; and
a computation unit to compute the first offset using the first time stamp, the second time stamp, the accumulated value, and the second propagation time.

40. The apparatus as claimed in claim 38, wherein the second offset computation unit computes the second offset according to equations:
$$\begin{matrix}{y}_{k} = {a}_{1} {y}_{k - 1} + {a}_{2} {y}_{k - 2} + ⋯ + {a}_{n} {y}_{k - n} + \\ {b}_{0} {u}_{k} + {b}_{1} {u}_{k - 1} + ⋯ + {b}_{m} {u}_{k - m}\end{matrix}$$
$$H ( z ) = \frac{{b}_{0} + {b}_{1} {z}^{- 1} + ⋯ + {b}_{m} {z}^{- m}}{1 - {a}_{1} {z}^{- 1} - {a}_{2} {z}^{- 2} - ⋯ - {a}_{n} {z}^{- n}}$$
where uₖ is the first offset, yₖ is the second offset, aᵢ(1<i<n) and bⱼ(0<j<m) are filter coefficients of the linear digital filter, and H(z) is a filter transfer function.

41. The apparatus as claimed in claim 38, wherein the apparatus is the slave node.
